(19) United States
(12) Patent Application Publication
(10) Pub. No.: US 2025/0232913 A1
(43) Pub. Date: Jul. 17, 2025

(54) METHOD FOR PRODUCING MAGNETIC SHEET

(71) Applicant: PROTERIAL, LTD., Tokyo (JP)

(72) Inventors: Kotoba TOYONAGA, Tokyo (JP); Yuichi OGAWA, Tokyo (JP); Kouhei MIYANO, Tokyo (JP); Yasuo KURIYAMA, Tokyo (JP)

(21) Appl. No.: 18/852,690

(22) PCT Filed: Mar. 29, 2023
(86) PCT No.: PCT/JP2023/012996

§ 371 Date: Sep. 30, 2024

(30) Foreign Application Priority Data
Mar. 30, 2022 (JP) 2022-055680

(51) Int. Cl. H01F 41/02; C22C 45/02; H01F 1/153

(52) U.S. Cl. CPC H01F 41/0226; C22C 45/02; H01F 1/15308; H01F 1/15333; H01F 1/15383

(57) ABSTRACT

Provided is a highly productive method for producing a magnetic sheet with a reduced number of times of unwinding and winding operations, and a method for producing a magnetic sheet with excellent magnetic characteristics and good isotropy. The method for producing a magnetic sheet includes a heat treatment process of heating an amorphous alloy ribbon to produce a nanocrystalline alloy ribbon, and a bonding process of bonding an adhesive layer to one surface of the nanocrystalline alloy ribbon. The heat treatment process involves bringing a ribbon pressing member into contact with a surface of the amorphous alloy ribbon opposite to a surface contacting a heater, and applying a tension of 18 MPa or less to the amorphous alloy ribbon. The bonding process is performed consecutively to the heat treatment process, and involves bonding an adhesive layer to one surface of the nanocrystalline alloy ribbon while conveying the nanocrystalline alloy ribbon.

### CROSS-REFERENCE TO RELATED APPLICATION

This international application claims the priority based on Japanese Patent Application No. 2022-055680 filed on Mar. 30, 2022 with the Japan Patent Office, and the entire disclosure of Japanese Patent Application No. 2022-055680 is incorporated by reference in this international application.

### TECHNICAL FIELD

The present disclosure relates to a method for producing a magnetic sheet in which an adhesive layer is bonded to one surface of a nanocrystalline alloy ribbon.

### BACKGROUND ART

In recent years, electronic devices such as smartphones, tablet information terminals, and mobile phones have rapidly become widespread. There are demands that mobile phones (for example, smartphones), Web terminals, music players, and the like in particular should be capable of continuous use for long periods of time to be convenient as portable devices. In these small-size portable devices, secondary batteries such as lithium-ion batteries are used as their power sources. There are some methods for charging the secondary batteries: a contact charging method in which charging is performed by bringing an electrode on a power reception side and an electrode on a power supply side into direct contact; and a contactless charging method in which transmission coils are provided on both the power supply side and the power reception side, and charging is performed by power transmission using electromagnetic induction. The contactless charging method does not require electrodes for making direct contact between a power feeding device and a power receiving device, thus enabling charging of various power receiving devices using the same power feeding device. The contactless charging method is a technique which can be used not only in portable devices but also in other electronic devices, electric vehicles, drones, and so on.

In the contactless charging method, a magnetic flux generated in a primary transmission coil of the power feeding device generates an electromotive force in a secondary transmission coil of the power receiving device through casings of the power feeding device and the power receiving device whereby a power is supplied. In order to achieve high power-transmission efficiency, the transmission coils are each provided with a magnetic sheet as a coil yoke on a side opposite to contact surfaces between the power feeding device and the power receiving device. The magnetic sheet has following roles.

A first role is as a magnetic shielding material. For example, if a leakage magnetic flux generated during a charging operation of a contactless charging device flows to other components such as metal members constituting a secondary battery, these components generate heat due to eddy currents. The magnetic sheet can inhibit such heat generation as a magnetic shielding material.

A second role of the magnetic sheet is to work as a yoke member that returns magnetic flux generated in the coil during charging.

Conventionally, ferrite materials have been the mainstream soft magnetic materials used for magnetic sheets of contactless charging devices. Recently, however, use of soft magnetic alloy ribbons made of amorphous alloys or nanocrystalline alloys has also began as disclosed in Japanese Unexamined Patent Application Publication No. 2008-112830.

Moreover, International Application Publication No. 2014/157526 discloses a magnetic sheet with a ribbon obtained by heat-treating a Fe-based amorphous and having a magnetic permeability μr of 220 or greater and 770 or less at 500 kHz.

In addition, International Application Publication No. 2020/235643 discloses a method for producing a nanocrystalline alloy ribbon with a resin film. The method includes: a process of preparing a non-crystalline alloy ribbon capable of nanocrystallization; a process of performing heat treatment for nanocrystallization while applying a tension to the non-crystalline alloy ribbon to obtain a nanocrystalline alloy ribbon; and a process of causing the nanocrystalline alloy ribbon to be held on a resin film with a glue layer therebetween. It is also disclosed that the method includes a process of forming cracks in the nanocrystalline alloy ribbon.

### PRIOR ART DOCUMENTS

### Patent Documents

Patent Document 1: Japanese Unexamined Patent Application Publication No. 2008-112830
Patent Document 2: International Application Publication No, 2014/157526
Patent Document 3: International Application Publication No. 2020/235643

### SUMMARY OF THE INVENTION

### Problems to be Solved by the Invention

Patent Document 1 does not disclose a specific means of a heat treatment method.

Patent Document 2 discloses a heat treatment process in which a thin sheet-shaped magnetic body 10, made from a Fe-based metal magnetic material and having a single layer thickness of 15 μm to 35 μm, is heat-treated to set an AC relative magnetic permeability μr of the thin sheet-shaped magnetic body 10 to 220 or greater and 770 or less at a frequency of 500 kHz, and a lamination process in which the heat-treated thin sheet-shaped magnetic body 10 is held on a resin film (substrate 20) with an adhesive layer 15 interposed between the thin sheet-shaped magnetic body 10 and the resin film to thereby form a magnetic sheet 1. The heat treatment process and the lamination process are independent processes.

Patent Document 3 discloses an unwinding operation, heat treatment, and a winding operation as a heat treatment process. Patent Document 3 discloses, separately from the heat treatment process, a process of causing a nanocrystalline alloy ribbon to be held on a resin film with a glue layer therebetween.

In cases where heat treatment is performed on an amorphous alloy ribbon to produce a nanocrystalline alloy ribbon, the amorphous alloy ribbon for the nanocrystalline alloy ribbon wound in a coil shape is unwound, heat-treated, and wound into a coil shape as described in Patent Document 3, for example.

Also, when a resin film is bonded to the nanocrystalline alloy ribbon, the nanocrystalline alloy ribbon wound in a coil shape is unwound, the resin film is bonded to the unwound ribbon with a glue layer interposed between the ribbon and the resin film, and the ribbon is wound into a coil shape as described in Patent Document 2 and Patent Document 3, for example.

In this way, in production of a magnetic sheet with the nanocrystalline alloy ribbon, the operations to unwind the ribbon wound in a coil shape, treat the ribbon, and wind the ribbon into a coil shape again are performed in every process, such as the heat treatment process and the resin film bonding process.

As described above, in production of a magnetic sheet with a nanocrystalline alloy ribbon, the operations to wind the ribbon into a coil shape and to unwind the ribbon in a coil shape are performed many times.

Furthermore, the nanocrystalline alloy ribbon is produced by ejecting a molten alloy adjusted to a specified alloy composition onto a rotating cooling roller, rapidly cooling the molten alloy for solidification to produce an alloy ribbon, and then heat-treating the alloy ribbon. The nanocrystalline alloy ribbon is produced as a long ribbon having a small thickness and a specified width. According to this production method, anisotropy is easily introduced in a casting direction (longitudinal direction), and, even after the alloy ribbon is heat-treated, magnetic characteristics tend to be different between the longitudinal direction of the long shape and a width direction orthogonal to the longitudinal direction.

For some applications, the nanocrystalline alloy ribbon is required to have magnetic characteristics that are as isotropic as possible. However, as described above, it has been difficult to obtain a nanocrystalline alloy ribbon having excellent magnetic characteristics (high saturation magnetic flux density and low iron loss) and good isotropy by a highly productive method.

An object of the present disclosure is to provide a highly productive method for producing a magnetic sheet by reducing the number of times of unwinding and winding operations. Another object is to provide a method for producing a magnetic sheet that includes a nanocrystalline alloy ribbon having excellent magnetic characteristics and good isotropy.

### Means for Solving the Problems

A method for producing a magnetic sheet according to a first aspect of the present disclosure includes a heat treatment step of heat-treating an amorphous alloy ribbon to produce a nanocrystalline alloy ribbon, and a bonding step of bonding an adhesive layer to one surface of the nanocrystalline alloy ribbon,
the heat treatment step involving: unwinding the amorphous alloy ribbon from the amorphous alloy ribbon wound in a coil shape; bringing the amorphous alloy ribbon into contact with a heater while conveying the amorphous alloy ribbon; bringing a ribbon pressing member into contact with a surface of the amorphous alloy ribbon opposite to a surface of the amorphous alloy ribbon in contact with the heater to thereby heat the amorphous alloy ribbon while pressing the amorphous alloy ribbon against the heater; and applying a tension of 18 MPa or less to the amorphous alloy ribbon to introduce the amorphous alloy ribbon to the heater, and
the bonding step involving bonding the adhesive layer to the one surface of the nanocrystalline alloy ribbon while conveying the nanocrystalline alloy ribbon that has been conveyed from the heat treatment step.

### Effects of the Invention

According to the present disclosure, it is possible to provide a highly productive method for producing a magnetic sheet by reducing the number of times of unwinding and winding operations. It is also possible to provide a method for producing a magnetic sheet that includes a nanocrystalline alloy ribbon having excellent magnetic characteristics and good isotropy.

### BRIEF DESCRIPTION OF THE DRAWINGS

FIG. 1 is a conceptual view illustrating one embodiment of the present disclosure.

FIG. 2 is a conceptual view illustrating an embodiment of a heat treatment process of the present disclosure.

FIG. 3 is a sectional view illustrating a structure of an adhesive layer of the present disclosure.

FIG. 4 is a sectional view illustrating a structure in which a protective sheet of the adhesive layer of the present disclosure has been peeled off.

FIG. 5 is a sectional view illustrating a structure in which a nanocrystalline alloy ribbon is bonded to the adhesive layer of the present disclosure.

FIG. 6 is a sectional view illustrating a structure in which cracks are formed in the nanocrystalline alloy ribbon bonded to the adhesive layer of the present disclosure.

FIG. 7 is a sectional view illustrating a structure of one embodiment of a magnetic sheet of the present disclosure.

### MODE FOR CARRYING OUT THE INVENTION

Hereinafter, embodiments of the present disclosure will be described in detail. The present disclosure is not limited in any way to the embodiments below, and can be implemented with appropriate modifications within the scope of the objects of the present disclosure.

In the present disclosure, a numerical range shown using “to” indicates a range that includes numerical values before and after “to” as a lower limit and an upper limit, respectively. In numerical ranges in the present disclosure that are described in stages, an upper limit or a lower limit described in a numerical range may be replaced with an upper limit or a lower limit of another numerical range described in stages. In addition, in numerical ranges described in the present disclosure, an upper limit or a lower limit of a numerical range may be replaced with a value shown in examples.

In the present disclosure, a combination of two or more preferred aspects is a more preferred aspect,

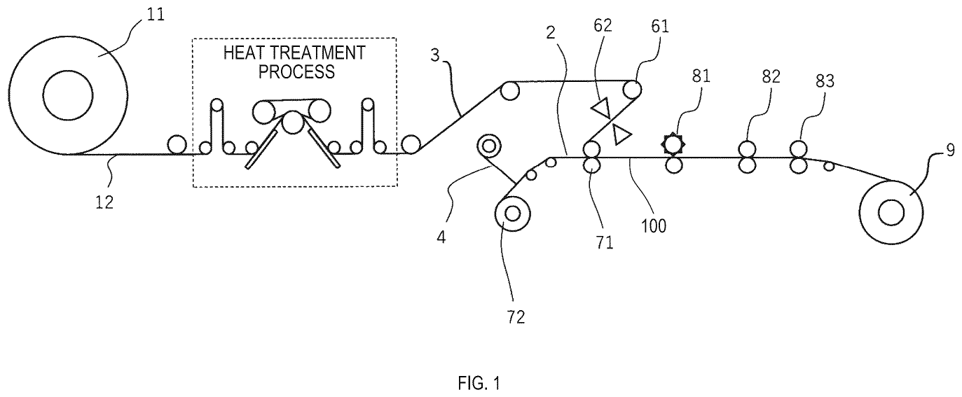

FIG. 1 shows a conceptual view illustrating a method for producing a magnetic sheet according to one embodiment of the present disclosure.

In the method of FIG. 1, first, an amorphous alloy ribbon 12 for a nanocrystalline alloy ribbon 3 wound in a coil shape is prepared. FIG. 1 shows a wound body 11 which is the amorphous alloy ribbon 12 for the nanocrystalline alloy ribbon 3 wound in a coil shape. From this wound body 11, the amorphous alloy ribbon 12 (hereinafter, also simply referred to as “ribbon 12”.) is unwound. The unwound amorphous alloy ribbon 12 is conveyed to a heat treatment process.

### <Heat Treatment Process>

A heat treatment method of the present disclosure is a method of heating the amorphous alloy ribbon 12 by bringing the amorphous alloy ribbon 12 into contact with a heater. When the amorphous alloy ribbon 12 is brought into contact with the heater and heated, the amorphous alloy ribbon 12 is conveyed, and a ribbon pressing member is brought into contact with a surface of the amorphous alloy ribbon 12 opposite to a surface of the amorphous alloy ribbon 12 in contact with the heater. The amorphous alloy ribbon 12 is heated while being pressed against the heater.

In the present disclosure, a flexible member may be used as the ribbon pressing member.

The flexible member is preferably a metal member. The flexible member means a member that can deform along a roller.

The ribbon pressing member may be a belt or a roller.

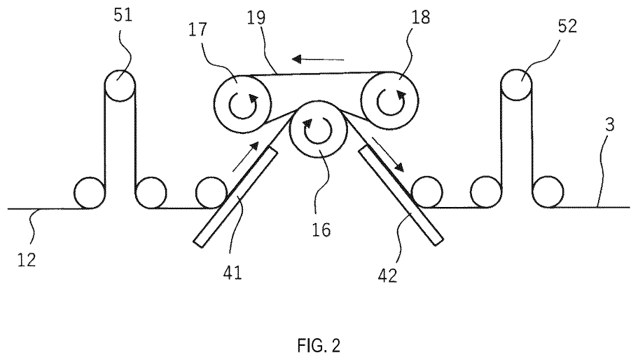

FIG. 2 shows a conceptual view of the heat treatment process.

The amorphous alloy ribbon 12 which has been unwound is subjected to tension adjustment at dancer rollers 51, 52. The amorphous alloy ribbon 12 to which a specified tension is applied is brought into contact with a heating roller 16, which works as the heater, and heated. In the amorphous alloy ribbon 12, nanocrystals are formed by this heating, and thus the amorphous alloy ribbon 12 becomes the nanocrystalline alloy ribbon 3.

At this time, the tension applied to the amorphous alloy ribbon 12 is preferably 18 MPa or less. The tension is more preferably 17 MPa or less. Also, the tension is preferably 3 MPa or greater, more preferably 3.5 MPa or greater, and more preferably 5.5 MPa or greater.

In the present embodiment, an adhesive layer 2 is bonded to the nanocrystalline alloy ribbon 3 after the heat treatment process. During this bonding of the adhesive layer 2, a tension is applied to the adhesive layer 2 and the bonding is performed. After the adhesive layer 2 is bonded to the nanocrystalline alloy ribbon 3, the tension applied to the adhesive layer 2 is released, and thereby the adhesive layer 2 tries to shrink. As a result, the nanocrystalline alloy ribbon 3 is subjected to stress in a direction in which the adhesive layer 2 tries to shrink.

If extra stress is applied to the nanocrystalline alloy ribbon 3, there is a risk that desired magnetic characteristics may not be obtained.

In the present disclosure, by applying the tension to the amorphous alloy ribbon 12 and performing heat treatment, it is possible to expect an effect of inhibiting deterioration of characteristics which may be caused due to the stress in the direction in which the adhesive layer 2 tries to shrink after being bonded. This makes it possible to inhibit deterioration of magnetic characteristics which may be caused if unnecessary stress is applied to the nanocrystalline alloy ribbon 3. Nevertheless, if a large tension is applied to the amorphous alloy ribbon 12, it becomes difficult to obtain isotropy. Thus, it is preferred to apply a tension of 18 MPa or less to the amorphous alloy ribbon 12 and introduce the amorphous alloy ribbon 12 to the heater,

FIG. 2 shows the heating roller 16, a ribbon pressing metal belt 19 that works as the ribbon pressing member, a first roller 17 on an upstream side of the process, and a second roller 18 on a downstream side of the process that support the ribbon pressing metal belt 19; these components can be used in the heat treatment process of the present embodiment. The ribbon pressing metal belt 19 is one example of a means to press the amorphous alloy ribbon 12 against the heating roller 16.

The amorphous alloy ribbon 12 is led between the heating roller 16 and the ribbon pressing metal belt 19 and heated while being pressed against the heating roller 16. Arrows in FIG. 2 show movement of respective components. The heating roller 16, the first roller 17, and the second roller 18 have rotating structures. Accordingly, the amorphous alloy ribbon 12 is heated while being conveyed and pressed against the heating roller 16.

The ribbon 12 becomes the nanocrystalline alloy ribbon 3 after being heated by the heating roller 16.

It is preferred that heating rollers capable of heating are used also for the first and the second rollers 17, 18. The ribbon pressing metal belt 19 is preferably preheated with these rollers. In a case where the first and the second rollers 17, 18 are heating rollers, a temperature of the ribbon pressing metal belt 19 (that is, a temperature when the ribbon pressing metal belt 19 comes into contact with the ribbon 12) is preferably equal to or slightly lower than a temperature for heating the ribbon 12. Temperatures of the first and the second rollers 17, 18 may be temperatures that allow the ribbon pressing metal belt 19 to be at a suitable temperature. For example, it is desirable that the temperatures of the first and the second rollers 17, 18 are set to be approximately 50° C. higher than a temperature of the heating roller 16. The temperatures of the ribbon pressing metal belt 19, the first roller 17, and the second roller 18 can be selected to be suitable for heat-treating the ribbon 12.

FIG. 2 shows a first guide slope 41 for the ribbon 12 on the upstream side of the process and a second guide slope 42 on the downstream side of the process. Use of the inclined first and second guide slopes 41, 42 before and after the heating roller 16 (that is, both upstream and downstream of the process) enables the amorphous alloy ribbon 12 to be supplied to the heating roller 16 in a manner such that the amorphous alloy ribbon 12 is brought into contact simultaneously with the ribbon pressing metal belt 19 and the heating roller 16 and to be discharged in the same manner. In other words, adjustment of inclination angles of the first and the second guide slopes 41, 42 to set supply and discharge angles of the amorphous alloy ribbon 12 enables a topside and an underside of the amorphous alloy ribbon 12 to be simultaneously heated and simultaneously cooled. It is more preferred that the first and the second guide slopes 41, 42 are arranged such that respective extension lines of the first and the second guide slopes 41, 42 coincide with tangents of the heating roller 16. The topside and the underside of the amorphous alloy ribbon 12 mean a first surface of the amorphous alloy ribbon 12 and a second surface of the amorphous alloy ribbon 12 on the opposite side of the first surface.

The ribbon pressing metal belt 19 is an example of the flexible member, and the flexible member is preferably a metal member from a standpoint of flexibility and strength. For example, it is more preferred to use a material with an excellent heat resistance such as a heat-resistant stainless steel or a nickel-based super heat-resistant alloy as the flexible member.

According to the above-described heat treatment method, a structure is provided in which the flexible member (the ribbon pressing metal belt 19 in the present embodiment) is brought into contact with the surface of the amorphous alloy ribbon 12 opposite to the surface in contact with the heating roller 16 to press the amorphous alloy ribbon 12 against the heating roller 16. This enables the amorphous alloy ribbon 12 to be pressed against the heating roller 16. It is preferred that the amorphous alloy ribbon 12 is brought into close contact with the heating roller 16 by the ribbon pressing metal belt 19, and thereby the amorphous alloy ribbon 12, the ribbon pressing metal belt 19, and the heating roller 16 move in unison.

The heating roller 16 is an example of the heater (heater of the present disclosure) that comes into direct contact with the amorphous alloy ribbon 12 to heat the same. The amorphous alloy ribbon 12 is brought into contact with a portion of an outer circumferential surface (that is, a portion of circumferential area) of the cylindrical heating roller 16 and heated. The heating roller 16 may have a driving force for conveying the amorphous alloy ribbon 12. A roller for driving the ribbon pressing metal belt 19 may be both or any one of the first or the second rollers 17, 18. For example, a configuration may be adopted in which the second roller 18 on the downstream side of the process has a driving force, and the first roller 17 on the upstream side of the process is mechanically dependent on the second roller 18. This makes it possible to avoid complicated control of the first roller 17 and the second roller 18 such as electrical synchronization, and to eliminate need for correcting synchronization errors caused by a difference in thermal expansion between the first roller 17 and the second roller 18.

The heating roller 16 is one example of the heater that includes a convex surface which comes into contact with the amorphous alloy ribbon 12 to heat the same. The “convex surface” means a surface raised toward the amorphous alloy ribbon 12. The convex surface may include a curved surface formed by a side surface of a cylindrical (or columnar) shape as in the case of the heating roller 16 shown in FIG. 1 or a curved surface formed in a portion of a member such as a curved-surface portion of a substantially D-shaped member, for example. The convex surface may be in any shape that allows the amorphous alloy ribbon 12 to follow and ensures sufficient contact. The heater of the present disclosure may be configured to be non-rotating, and the ribbon 12 may be configured to move (that is, slide) on the heater.

In the heat treatment method of the present disclosure, a ribbon pressing roller may be used as the ribbon pressing member. It is preferred that a heating roller capable of heating is used also for the ribbon pressing roller.

In the heat treatment method of the present disclosure, a configuration may be adopted in which the heater is substantially D-shaped in place of the heating roller 16, and the ribbon pressing metal belt and rollers supporting the ribbon pressing metal belt are provided as a means to press the amorphous alloy ribbon 12 against the heater. In this case, the heater may have a fixed structure, and a structure may be employed in which the amorphous alloy ribbon 12 slides on the heater. The amorphous alloy ribbon 12 is pressed against the heater by the ribbon pressing metal belt. As a result, the amorphous alloy ribbon 12 is heated while being conveyed and being pressed against the heater.

In the heat treatment method of the present disclosure, a temperature increase rate of the amorphous alloy ribbon 12 is preferably 50° C./sec to 4000° C./sec. When the nanocrystalline alloy ribbon 3 is obtained by the heat treatment, a temperature increase rate for achieving a fine nanocrystal structure varies from one composition to another; however, a fast temperature increase rate is required for a composition with a low Cu, low M element, and high Fe content, which provides a high saturation magnetic flux density. In a case of one embodiment of the present disclosure, a lower limit of the temperature increase rate is 50° C./sec, and an upper limit, which can be determined by an equipment capacity of a heat treatment apparatus, temperatures of the heater and the ribbon pressing member, a contact state of the heater and the ribbon pressing member with the ribbon 12, and so on, is substantially about 4000° C./sec. The upper limit is preferably 500° C./sec or higher.

The heater preferably has a width larger than a width of the amorphous alloy ribbon 12. As a result, when the amorphous alloy ribbon 12 is pressed against the heater, an entire width of the ribbon 12 is in close contact with the heater. In addition, it is preferred that the ribbon pressing member also has a width larger than the width of the amorphous alloy ribbon 12. This facilitates a close contact of the entire width of the ribbon 12 with the heater when the amorphous alloy ribbon 12 is pressed against the heater.

In addition, when the amorphous alloy ribbon 12 is heated while being pressed against the heater, a distance from a point where the amorphous alloy ribbon 12 comes into contact with the heater to a point where the amorphous alloy ribbon 12 leaves the heater is preferably 50 mm or greater in terms of a length of a surface of the heater. The distance from the point where the amorphous alloy ribbon 12 comes into contact with the heater to the point where the amorphous alloy ribbon 12 leaves the heater is more preferably 150 mm or greater in terms of the length of the surface of the heater. This distance corresponds to a moving distance of the amorphous alloy ribbon 12 from the point where the amorphous alloy ribbon 12 comes into contact with the heater to the point where the amorphous alloy ribbon 12 leaves the heater.

A conveying speed of the amorphous alloy ribbon 12 is preferably 1 m/min or greater. In mass production, a production volume increases with an increase in the conveying speed, and thus the conveying speed is more preferably 10 m/min or greater.

A contact time during which the amorphous alloy ribbon 12 and the heater are in contact with each other is preferably 0.1 seconds to 30 seconds. A lower limit of the contact time is more preferably 0.2 seconds. An upper limit of the contact time is more preferably 10 seconds, still more preferably 5 seconds, and most preferably 2 seconds. To improve mass productivity by fast and stable production, the contact time is preferably 0.2 seconds to 2 seconds.

According to the heat treatment method of the present disclosure, by pressing the amorphous alloy ribbon 12 against the heater, the heater and the ribbon 12 come into better contact, and heat transfer is improved, and the temperature increase rate is increased; in addition, it enables more heat generated by crystallization to escape to the heater and a ribbon pressing metal (belt or roller), thus making it possible to suppress the maximum temperature of the ribbon 12 (that is, to suppress a temperature rise due to self-generated heat). Furthermore, by pressing the ribbon 12 against the ribbon pressing member (belt or roller), it is possible to inhibit wrinkles or lines that tend to be formed during crystallization. This enables the heat treatment at a higher temperature and the heat treatment with a fast temperature increase rate and a short contact time. Therefore, the heat treatment method of the present disclosure can improve productivity and yield a uniform nanocrystalline structure, thus enabling obtainment of the nanocrystalline alloy ribbon 3 with a higher saturation magnetic flux density and excellent magnetic characteristics.

A pressure to press the amorphous alloy ribbon 12 against the heater is preferably 0.03 MPa or greater. The pressure to press is more preferably 0.04 MPa or greater, still more preferably 0.05 MPa or greater, and still more preferably 0.07 MPa or greater.

For better contact between the amorphous alloy ribbon 12 and the heater, the heater is given a curvature. For the curvature of the heater, its radius of curvature is preferably 25 mm or greater.

In order to increase the temperature increase rate of the amorphous alloy ribbon 12 during heating, it is also effective to heat the ribbon pressing metal (belt or roller) to a temperature equal to a temperature of the heater and heat the ribbon on both surfaces. In order to suppress heat generation due to bccFe crystallization of the ribbon, it is also effective to set the temperature of the ribbon pressing metal (belt or roller) lower than a temperature Ta° C. of the heater.

### <Bonding Process>

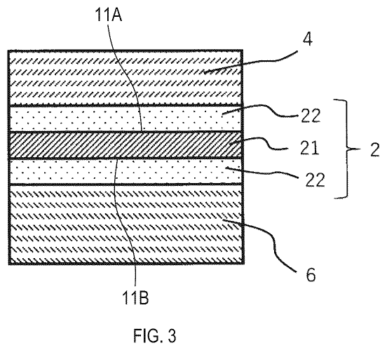

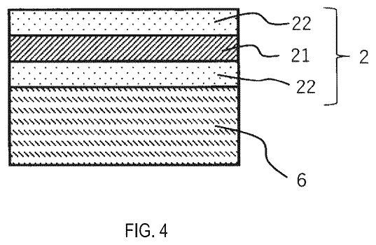

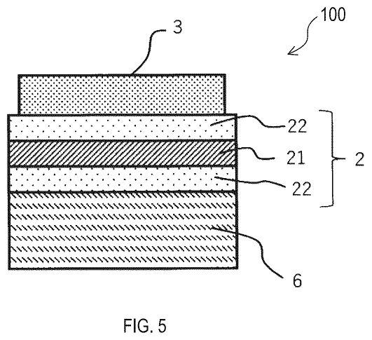

After the heat treatment process, the nanocrystalline alloy ribbon 3 is conveyed to a process of bonding the adhesive layer 2. Hereinafter, the process will be described with reference to FIG. 3 to FIG. 7. FIG. 3 and FIG. 4 are sectional views for describing a configuration of the adhesive layer 2 and sectional views in a direction intersecting (for example, a direction orthogonal to) a longitudinal direction of the adhesive layer 2. FIG. 5 to FIG. 7 are sectional views for describing a configuration of a magnetic sheet 100 and sectional views in a direction intersecting (for example, a direction orthogonal to) a longitudinal direction of the magnetic sheet 100.

FIG. 3 shows a sectional view of a structure of the adhesive layer 2. The adhesive layer 2 includes a support 21 and an adhesive 22 provided on each surface of the support 21. More specifically, the adhesive 22 is provided in the form of a film or a layer on each of a first surface 11A and a second surface 11B of the support 21. A protective sheet 4 is adhered to the adhesive 22 on the first surface 11A of the support 21 of the adhesive layer 2, and a liner 6 is adhered to the adhesive 22 on the second surface 11B of the support 21. The support 21 is an elongated band-shaped film member such as a rectangular film member. The support 21 is formed using a flexible resin material. As the resin material, polyethylene terephthalate (PET: Polyethyleneterephthalate) can be used. A pressure-sensitive adhesive can be used as an example of the adhesive 22. Examples of the adhesive 22 that can be used include publicly known adhesives such as acrylic adhesives, silicone-based adhesives, urethane-based adhesives, synthetic rubbers, and natural rubbers. Acrylic adhesives are preferred as the adhesive 22 since acrylic adhesives have excellent heat resistance and moisture resistance and can be bonded to a wide variety of materials.

For example, the adhesive layer 2 having a total thickness of 3 μm can be used which is a sum of thicknesses of the adhesive 22 on the first surface 11A of the support 21, the support 21, and the adhesive 22 on the second surface 11B of the support 21.

At least one of the protective sheet 4 or the liner 6 adhered to the adhesive layer 2 may be removed to thereby allow the adhesive layer 2 to be bonded to another member.

As shown in FIG. 1, the adhesive layer 2 is unwound from a wound body 72 formed by the wound adhesive layer 2, and the protective sheet 4 which is attached to the adhesive 22 on the first surface 11A of the support 21 of the adhesive layer 2 is peeled off to expose the adhesive 22 on the first surface 11A. This state is shown in FIG. 4. Then, the adhesive layer 2 with the adhesive 22 on the first surface 11A exposed and the nanocrystalline alloy ribbon 3 are individually conveyed and guided to bonding rollers 71. Then, the adhesive layer 2 with the adhesive 22 on the first surface 11A exposed and the nanocrystalline alloy ribbon 3 are bonded using the bonding rollers 71. The bonded state is shown in FIG. 5. At this time, the adhesive layer 2 is conveyed under tension, and the nanocrystalline alloy ribbon 3 is also conveyed under tension. Then, the adhesive layer 2 and the nanocrystalline alloy ribbon 3 are bonded to each other.

In addition, the nanocrystalline alloy ribbon 3, before being guided to the bonding rollers 71, passes through a ribbon end-face aligning device 61 and then passes through a ribbon end-face detector 62. A ribbon end-face of the nanocrystalline alloy ribbon 3 is adjusted, and then bonding to the adhesive layer 2 is performed. As a result, bonding is performed with a positional relationship between the nanocrystalline alloy ribbon 3 and the adhesive layer 2 adjusted.

The ribbon end-face aligning device 61 includes a mechanism that moves the nanocrystalline alloy ribbon 3 to be tilted in a width direction, and aligns the same.

The bonding process with the bonding rollers 71 enables production of the magnetic sheet 100 made of the nanocrystalline alloy ribbon 3 having the adhesive layer 2 bonded to one side as shown in FIG. 5. In FIG. 1, the magnetic sheet 100 made by bonding the nanocrystalline alloy ribbon 3 and the adhesive layer 2 is conveyed to a cracking process performed with a cracking roller 81. Alternatively, the magnetic sheet 100 may be wound into a coil shape after bonding of the nanocrystalline alloy ribbon 3 and the adhesive layer 2 without the cracking process being performed. The magnetic sheet 100 may be cut to a desired length.

The magnetic sheet 100 shown in FIG. 1 includes a layer of the nanocrystalline alloy ribbon 3. Using two or more of such magnetic sheets 100 and stacking the same, a magnetic sheet may be produced in which two or more of the nanocrystalline alloy ribbons 3 are stacked. In this case, it is possible to form the magnetic sheet in which multiple layers of the nanocrystalline alloy ribbons 3 are stacked by peeling off the liner 6 of the above-described magnetic sheet 100 and by bonding and stacking another nanocrystalline alloy ribbon 3.

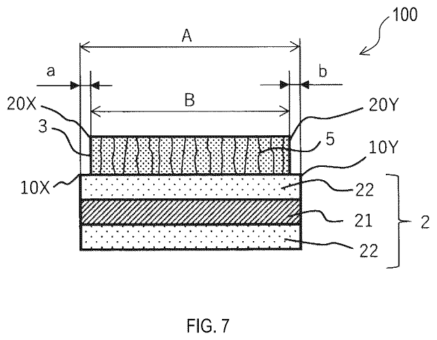

FIG. 7 shows a positional relationship between the nanocrystalline alloy ribbon 3 and the adhesive layer 2 in the magnetic sheet 100 according to one embodiment of the present disclosure. It is preferred that the nanocrystalline alloy ribbon 3 and the adhesive layer 2 have respective shapes that satisfy a relationship of a following formula. (see FIG. 7)

$$0.2 mm \leq ( width A - width B ) \leq 3 mm$$

The width A is a dimension related to the adhesive layer 2, more preferably a dimension related to a region of the adhesive layer 2 in which the adhesive 22 to be bonded with the nanocrystalline alloy ribbon 3 is provided. The width B is a dimension related to the nanocrystalline alloy ribbon 3. In a case where the adhesive 22 is provided on an entire surface of the support 21 of the adhesive layer 2, the width A is a dimension related to the adhesive layer 2 or the support 21.

A lower limit of (width A-width B) is preferably 0.5 mm, and more preferably 1.0 mm. An upper limit of (width A-width B) is preferably 2.5 mm, and more preferably 2.0 mm.

The nanocrystalline alloy ribbon 3 may be arranged such that its center in the width direction coincides with a center of the adhesive layer 2, or may be arranged such that its center is away from the center of the adhesive layer 2. In this case, the nanocrystalline alloy ribbon 3 is arranged in a manner to satisfy relationships of 0 mm<gap a, and 0 mm<gap b (see FIG. 7.).

The gap a and the gap b are distances from respective ends of the adhesive layer 2 to respective ends of the nanocrystalline alloy ribbon 3. Specifically, the gap a is a distance from a first adhesive layer end 10X of the adhesive layer 2 to a first ribbon end 20X of the nanocrystalline alloy ribbon 3. The gap b is a distance from a second adhesive layer end 10Y of the adhesive layer 2 to a second ribbon end 20Y of the nanocrystalline alloy ribbon 3.

The first ribbon end 20X is an end of the nanocrystalline alloy ribbon 3 on the same side as the first adhesive layer end 10X. The second adhesive layer end 10Y is an end of the adhesive layer 2 opposite to the first adhesive layer end 10X. The second ribbon end 20Y is an end of the nanocrystalline alloy ribbon 3 on the same side as the second adhesive layer end 10Y

The width A, the width B, the gap a, and the gap b are dimensions in a direction intersecting the longitudinal direction of the magnetic sheet 100, more preferably in a direction orthogonal to the longitudinal direction of the magnetic sheet 100. The longitudinal direction of the magnetic sheet 100 and the longitudinal direction of the adhesive layer 2 are the same direction. The longitudinal direction of the magnetic sheet 100 and the longitudinal direction of the nanocrystalline alloy ribbon 3 are the same direction.

By making the width A of the region in the adhesive layer 2, in which the adhesive 22 is provided, larger than the width B of the nanocrystalline alloy ribbon 3, it is easy to arrange the adhesive 22 of the adhesive layer 2 on the entire surface of the nanocrystalline alloy ribbon 3 even if the adhesive lay^{e}r 2 and the nanocrystalline alloy ribbon 3 meander when the nanocrystalline alloy ribbon 3 is bonded to the adhesive layer 2. Such arrangement in which the adhesive layer 2 is on the entire surface of the nanocrystalline alloy ribbon 3 makes it possible to inhibit, after cracks 5 are formed and thereby small pieces are formed in the nanocrystalline alloy ribbon 3, fall-off of the small pieces.

By setting a value obtained by subtracting the width B from the width A to 0.2 mm or greater, it is easy to inhibit occurrence of a portion in the nanocrystalline alloy ribbon 3 on which the adhesive 22 is not placed when the nanocrystalline alloy ribbon 3 is bonded to the adhesive layer 2. By setting the value obtained by subtracting the width B from width A to 3 mm or less, it is easy to inhibit enlargement of a portion in the magnetic sheet 100 in which the nanocrystalline alloy ribbon 3 is not arranged. This setting also makes it easy, when the magnetic sheets 100 are placed side by side, to inhibit enlargement of an interval (magnetic gap) between the nanocrystalline alloy ribbons 3.

By satisfying the relationships 0 mm<gap a, and 0 mm<gap b, the nanocrystalline alloy ribbon 3 is inhibited from protruding from a region in which the adhesive 22 is arranged when the nanocrystalline alloy ribbon 3 is bonded to the adhesive layer 2. Thus, it is easy to inhibit occurrence of the portion in the nanocrystalline alloy ribbon 3 on which the adhesive 22 is not arranged. This makes it possible to inhibit fall-off of the small pieces after the cracks are formed and thereby small pieces are formed in the nanocrystalline alloy ribbon 3.

Moreover, in a case where the magnetic sheet 100 is adhered to another material, the adhesive layer 2 is present without exception between the nanocrystalline alloy ribbon 3 and another nanocrystalline alloy ribbon 3 or another material; thus it is possible to ensure insulation and adhesion.

### <Cracking Process>

It is preferred that the cracking process is provided after the bonding process.

In one embodiment of the present disclosure shown in FIG. 1, after the adhesive layer 2 is bonded to one surface of the nanocrystalline alloy ribbon 3 using the bonding rollers 71, the nanocrystalline alloy ribbon 3 is conveyed to the cracking process performed with the cracking roller 81.

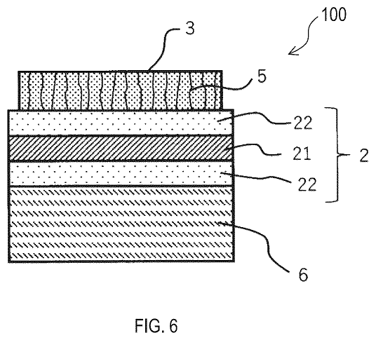

In the cracking process, the cracking roller 81 is pressed against the nanocrystalline alloy ribbon 3 to form the cracks 5 in the nanocrystalline alloy ribbon 3. The cracking roller 81 includes a specified protruding portion on its surface. With this protruding portion, an external force is directly applied to the nanocrystalline alloy ribbon 3 to form the cracks 5 in the nanocrystalline alloy ribbon 3. Since the cracking roller 81 is brought into direct contact with the nanocrystalline alloy ribbon 3, it is possible to easily form the cracks 5. On an adhesive layer 2 side of the nanocrystalline alloy ribbon 3, a pressing roller is provided. FIG. 6 shows a sectional view of a structure in which the cracks 5 are formed.

After the cracking process, the magnetic sheet 100 is fed to a nip roller unit 82 and a flattening roller unit 83, and wound around a wound body 9.

A process with the flattening roller unit 83 is to hold the magnetic sheet 100 between rollers to flatten unevenness created on the magnetic sheet 100 by the cracking process. In other words, the process with the flattening roller unit 83 is to feed the magnetic sheet 100 between the rollers set with a specified pressure. The specified pressure is preferably 0.1 to 1.0 MPa.

One embodiment of the present disclosure provides a method for producing the magnetic sheet 100 in which the adhesive layer 2 is bonded to one surface of the nanocrystalline alloy ribbon 3. In the method, the amorphous alloy ribbon 12 for the nanocrystalline alloy ribbon 3 wound in a coil shape is prepared, the amorphous alloy ribbon 12 is unwound from the wound body 11 in a coil shape, and the heat treatment process and the bonding process are performed consecutively on the amorphous alloy ribbon 12. Conventionally, a nanocrystalline alloy ribbon is wound around a wound body in a coil shape after heat treatment, the nanocrystalline alloy ribbon is unwound from the wound body, and an adhesive layer is bonded to the nanocrystalline alloy ribbon. In contrast, according to the embodiment of the present disclosure, the heat treatment process and the bonding process are performed with a single unwinding operation.

As a result, according to one embodiment of the present disclosure, it is possible to reduce the number of times of unwinding and winding operations and achieve a highly productive method for producing a magnetic sheet.

In addition, by including the cracking process as in one embodiment of the present disclosure shown in FIG. 1, it is possible to produce the magnetic sheet 100 formed of the nanocrystalline alloy ribbon 3 with the adhesive layer 2 bonded to one surface thereof and with the cracks 5 formed therein as shown in FIG. 6. This provides a highly productive method for producing the magnetic sheet 100.

In one embodiment of the present disclosure, in the heat treatment process, the amorphous alloy ribbon 12 is held between the heater and the ribbon pressing member and heated. Furthermore, the amorphous alloy ribbon 12 is heated while being pressed against the heater by the ribbon pressing member that is brought into contact with the surface of the amorphous alloy ribbon 12 opposite to the surface of the amorphous alloy ribbon 12 in contact with the heater. By heating the amorphous alloy ribbon 12 while the amorphous alloy ribbon 12 is held and pressed in this manner, it is possible to uniformly heat the amorphous alloy ribbon 12. This makes it possible to provide the nanocrystalline alloy ribbon 3 with excellent magnetic characteristics.

In addition, according to this heat treatment, by heating the amorphous alloy ribbon 12 while the amorphous alloy ribbon 12 is held and pressed, it is possible to provide the amorphous alloy ribbon 12 with excellent isotropy.

For example, it is preferred that a ratio (B80_{L}/B80_{W}) of a magnetic flux density B80_{L} when a magnetic field of 80 A/m is applied to the magnetic sheet 100, which is made of the nanocrystalline alloy ribbon 3 of the present disclosure, in the longitudinal direction thereof to a magnetic flux density B80_{W} when a magnetic field 80 A/m is applied in a width direction orthogonal to the longitudinal direction is 0.60 to 1.40, and both B80_{L} and B80_{W} are 0.1 T or greater. The ratio (B80_{L}/B80_{W}) is more preferably 0.70 to 1.30. Both B80_{L} and B80_{W} are more preferably 0.4 T or greater, more preferably 0.5 T or greater.

Furthermore, the heat treatment of the present disclosure makes it possible to suppress occurrence of wrinkles or lines by holding and pressing the amorphous alloy ribbon 12. This is also effective in correcting wrinkles and the like resulting from non-uniform cooling that occurs during casting of the amorphous alloy ribbon 12. As a result, according to the present disclosure, it is possible to inhibit wrinkles or lines and provide the nanocrystalline alloy ribbon 3 with good flatness.

In addition, the nanocrystalline alloy ribbon 3 of the present disclosure is represented by a composition formula (Fe₁₋ₓAₓ)ₐSi_{b}B_{c}Cu_{d}Mₑ where A is at least one of Ni and Co, M is at least one element selected from Nb, Mo, V, Zr, Hf and W, and atomic percentages are preferably 72.0≤a≤81.0, 9.0≤b≤18.0, 5.0≤c≤10.0, 0.02≤d≤1.5, 0.1≤e≤3.5, and 0≤x≤0.1.

In addition, in the heat treatment of the present disclosure, when a bccFe crystallization starting temperature measured at a temperature increase rate of 20 K/min of the amorphous alloy ribbon 12 is Tx1° C., it is preferred that the heater is heated to a heating temperature Ta of Tx1+80° C. or higher and Tx1+230° C. or lower.

The nanocrystalline alloy ribbon 3 of the present disclosure preferably has a thickness of 25 μm or less, and more preferably 20 μm or less. The thickness is preferably 5 μm or greater, and more preferably 10 μm or greater. Also, the nanocrystalline alloy ribbon 3 of the present disclosure preferably has a width of 10 mm or greater, more preferably 30 mm or greater, and still more preferably 50 mm or greater.

In addition, if the nanocrystalline alloy ribbon 3 of the present disclosure is too wide, stable production thereof becomes difficult. Thus, the nanocrystalline alloy ribbon 3 preferably has a width of 500 mm or less. More preferably, the width is 400 mm or less.

In addition, the nanocrystalline alloy ribbon 3 of the present disclosure preferably has a saturation magnetic flux density Bs of 1.15 T or greater. The saturation magnetic flux density Bs is more preferably 1.20 T or greater, still more preferably 1.35 T or greater, still more preferably 1.36 T or greater, still more preferably 1.37 T or greater, and still more preferably 1.40 T.

### Example 1

Element sources were mixed so that an alloy composition became Fe_{76.8}Si_{14.0}B_{8.0}Cu_{0.7}Nb_{0.5}, and heated to 1350° C. to produce a molten alloy. Then, the molten alloy was ejected onto a cooling roller having an outer diameter of 400 mm and a width of 200 mm and rotating at a peripheral speed of 30 m/sec, rapidly cooled and solidified on the cooling roller to produce the amorphous alloy ribbon 12. An outer circumferential portion of the cooling roller is made of a Cu alloy with a thermal conductivity of 150 W/(m·K) and includes inside thereof a cooling mechanism for controlling a temperature of the outer circumferential portion.

This amorphous alloy ribbon 12 had a width of 50 mm and a thickness of 16.4 μm.

This amorphous alloy ribbon 12 was wound to form the wound body 11 wound in a coil shape.

Using this wound body 11 of the amorphous alloy ribbon 12, the magnetic sheet 100 was produced in accordance with the process shown in FIG. 1. At this time, the cracking process was not performed, and the process was performed up to where the adhesive layer 2 was bonded to the nanocrystalline alloy ribbon 3.

The amorphous alloy ribbon 12 was introduced to the heating roller 16 with tensions of 3.1 MPa, 5.0 MPa, 6.3 MPa, 12.5 MPa, 15.0 MPa, and 17.5 MPa.

At this time, the heating roller 16 was heated to 660° C., the conveying speed of the ribbon 12 was 50 mm/sec, the contact time between the ribbon 12 and the heating roller 16 was 1.2 seconds, and the pressure applied by the ribbon pressing member to press the ribbon 12 against the heating roll 16 was 0.115 MPa.

The adhesive layer 2 used had a thickness of 3 μm (the adhesive 22 on the first surface 11A of the support 21+the support 21+the adhesive 22 on the second surface 11B of the support 21). The magnetic sheet 100 including one layer of the nanocrystalline alloy ribbon 3 was produced, and by stacking five of such magnetic sheets 100, a magnetic sheet including five layers of the nanocrystalline alloy ribbons 3 was produced.

Also, the magnetic sheet 100 with cracks was produced in a similar manner using the cracking process shown in FIG. 1. By stacking five of such magnetic sheets 100 with cracks, a magnetic sheet including five layers of the nanocrystalline alloy ribbons 3 was produced. Characteristics of these five-layer magnetic sheets were evaluated. Results of the evaluation are shown in Table 1.

As shown in Table 1, to obtain a high saturation magnetic flux density Bs, the tension of the amorphous alloy ribbon 12 is preferably 17 MPa or less. Also, to obtain a good B80_{L}/B80_{W} ratio, the tension of the amorphous alloy ribbon 12 is preferably 3.5 MPa or greater, more preferably 5.5 MPa or greater.

TABLE 1

| | | | | | | | Average | |
|---|---|---|---|---|---|---|---|---|
| | | Ribbon | | | | Bs | crystal grain | Volume |
| Sample | Cracking | tension | B80_{L} | B80_{W} | | (B₈₀₀₀) | diameter | fraction |
| No. | process | MPa | T | T | B80_{L}/B80_{W} | T | nm | % |
| 1 | No | 3.1 | 0.81 | 0.47 | 1.73 | 1.39 | 32.0 | 85.8 |
| 2 | No | 5.0 | 0.82 | 0.50 | 1.63 | 1.40 | 31.8 | 85.9 |
| 3 | No | 6.3 | 0.94 | 0.85 | 1.11 | 1.40 | 30.4 | 89.4 |
| 4 | Yes | | 0.49 | 0.55 | 0.89 | 1.38 | | |
| 5 | No | 12.5 | 0.76 | 0.81 | 0.93 | 1.40 | 31.1 | 88.5 |
| 6 | Yes | | 0.42 | 0.54 | 0.78 | 1.39 | | |
| 7 | No | 15.0 | 0.75 | 0.94 | 0.80 | 1.38 | 31.2 | 88.5 |
| 8 | Yes | | 0.38 | 0.56 | 0.67 | 1.37 | | |
| 9 | No | 17.5 | 0.54 | 0.93 | 0.58 | 1.34 | 30.7 | 89.7 |
| 10 | Yes | | 0.30 | 0.55 | 0.56 | 1.36 | | |

### [Saturation Magnetic Flux Density Bs]

A magnetic field of 8000 A/m was applied using DC Magnetization Characteristics Test Equipment manufactured by Metron Giken Co., Ltd. to a single sheet sample of the nanocrystalline alloy ribbon 3 after being heat-treated. A maximum magnetic flux density at that time was measured and taken as Bs. The nanocrystalline alloy ribbon 3 of the present disclosure has characteristics of being relatively easily saturated and thus was saturated when the magnetic field of 8000 A/m was applied, which renders values of B₈₀₀₀ and the saturation magnetic flux density Bs almost the same. Accordingly, the saturation magnetic flux density Bs is represented by B₈₀₀₀.

### [Magnetic Flux Density B80]

A magnetic field of 80 A/m was applied in each of a longitudinal direction (that is, the casting direction) of the magnetic sheet and a width direction orthogonal to the longitudinal direction using the DC Magnetization Characteristics Test Equipment manufactured by Metron Giken Co., Ltd. Maximum magnetic flux densities at these times were respectively taken as B80_{L}and B80_{W} and the B80_{L}/B80_{W} ratio was calculated to evaluate isotropy.

### [Average Crystal Grain Diameter]

The average crystal grain diameter was calculated from Scherrer equation using an integral width of a diffraction peak from a (110) plane in an X-ray diffraction pattern obtained from an X-ray diffraction experiment. The integral width of the diffraction peak from the (110) plane was determined by peak decomposition using a pseudo-Voigt function for the diffraction pattern. D is determined from the Scherrer equation (Mathematical Formula 1) given below, where the average grain diameter is represented by D, the integral width is represented by β, a diffraction angle is represented by θ, a Scherrer constant is represented by K, and a wavelength of an X-ray is represented by λ. In this case, however, assumptions applied were that the wavelength of the X-ray λ=0.154050 nm and the Scherrer constant K=1.333. As the integral width, a corrected value was used so that the integral width was narrowed by an amount of widening of a diffraction line width caused by the equipment.

$$D = \frac{K λ}{β cos θ} \qquad [ Mathematical Formula 1 ]$$

### [Volume Fraction]

The volume fraction is a volume fraction of nanocrystals, and portions other than the nanocrystals are non-crystalline portions.

This volume fraction is determined by a ratio of an integrated intensity of a diffraction peak from a Fe (110) plane to an integrated intensity of a halo pattern. The integrated intensity of the halo pattern is the integrated intensity of the diffraction peak from the Fe (110) plane plus an integrated intensity near 2θ=44°. The integrated intensities of the peak exhibited by the nanocrystals and the halo pattern exhibited by an amorphous are determined by peak decomposition using the pseudo-Voigt function for the X-ray diffraction patterns. A volume fraction V is calculated from a formula given below (Mathematical Formula 2), where the integrated intensity of the (110) peak of the nanocrystals is represented by Ic, and the integrated intensity of the halo pattern near 20=44° is represented by Ia. However, in the case of the composition in this example, peaks of integrated intensities of Fe and Fe₂B overlap, and decomposition is difficult; thus, an integrated intensity of Fe₂B that deposits although in a small amount may be also included in Ic and Ia.

$$V = \frac{Ic}{Ic + Ia} \times 100 \qquad [ Mathematical Formula 2 ]$$

According to the example of the present disclosure, it is possible to achieve a highly productive method for producing a magnetic sheet by reducing the number of times of unwinding and winding operations. In addition, it is possible to produce a magnetic sheet including a nanocrystalline alloy ribbon with excellent magnetic characteristics and good isotropy. For example, a nanocrystalline alloy ribbon having Bs of 1.15 T or greater is obtained, and B80_{L} and B80_{W} are both 0.10 T or greater. Furthermore, according to the present disclosure, it is possible to obtain a magnetic sheet that can obtain good isotropy. In addition, it is possible to obtain a magnetic sheet having a B80_{L}/B80_{W} ratio in a range of 0.60 to 1.40. In addition, it is possible to obtain a magnetic sheet that has a low coercivity Hc and exhibits excellent magnetic characteristics.

Furthermore, in the present disclosure, it is possible to obtain a nanocrystalline alloy ribbon having a structure, in which crystal grains having an average crystal grain diameter of 50 nm or less are present in an amorphous phase.

1. A method for producing a magnetic sheet, the method comprising;
a heat treatment step of heat-treating an amorphous alloy ribbon to produce a nanocrystalline alloy ribbon; and
a bonding step of bonding an adhesive layer to one surface of the nanocrystalline alloy ribbon,
the heat treatment step involving unwinding the amorphous alloy ribbon from the amorphous alloy ribbon wound in a coil shape, bringing the amorphous alloy ribbon into contact with a heater while conveying the amorphous alloy ribbon, bringing a ribbon pressing member into contact with a surface of the amorphous alloy ribbon opposite to a surface of the amorphous alloy ribbon in contact with the heater to thereby heat the amorphous alloy ribbon while pressing the amorphous alloy ribbon against the heater, and applying a tension of 18 MPa or less to the amorphous alloy ribbon to introduce the amorphous alloy ribbon to the heater, and
the bonding step involving bonding the adhesive layer to the one surface of the nanocrystalline alloy ribbon while conveying the nanocrystalline alloy ribbon that has been conveyed from the heat treatment step.

2. The method for producing a magnetic sheet according to claim 1, further comprising:
after the bonding step, a cracking step that involves bringing a cracking roller into direct contact with an opposite surface of the nanocrystalline alloy ribbon opposite to the one surface of the nanocrystalline alloy ribbon while conveying the nanocrystalline alloy ribbon, and applying pressure to the opposite surface of the nanocrystalline alloy ribbon with a cracking roller to form a crack in the nanocrystalline alloy ribbon.

3. The method for producing a magnetic sheet according to claim 1, wherein the magnetic sheet is wound into a coil shape after the bonding step.

4. The method for producing a magnetic sheet according to claim 2, wherein the magnetic sheet is wound into a coil shape after the cracking step.

5. The method for producing a magnetic sheet according to claim 1, wherein, when the amorphous alloy ribbon is brought into contact with the heater to be heated, a temperature increase rate of the amorphous alloy ribbon is 50° C./sec to 4000° C./sec.

6. The method for producing a magnetic sheet according to claim 1, wherein a contact time of the amorphous alloy ribbon with the heater is 0.1 seconds to 30 seconds.

7. The method for producing a magnetic sheet according to claim 1, wherein the nanocrystalline alloy ribbon includes a structure, in which crystal grains having an average crystal grain diameter of 50 nm or less are present in an amorphous phase.

8. The method for producing a magnetic sheet according to claim 1,
wherein the adhesive layer includes a support formed in a band shape and an adhesive provided on each of both surfaces of the support, and
wherein, when a dimension that is related to the adhesive layer and is in a direction intersecting a longitudinal direction of the adhesive layer is defined as a width A, and a dimension that is related to the nanocrystalline alloy ribbon and is in a direction intersecting a longitudinal direction of the nanocrystalline alloy ribbon is defined as a width B, the width A and the width B satisfy a relationship of 0.2 mm≤(width A-width B)≤3 mm.

9. The method for producing a magnetic sheet according to claim 1, wherein, before bonding of the adhesive layer to the nanocrystalline alloy ribbon, a device is arranged that is configured to align an end face of the nanocrystalline alloy ribbon.

10. The method for producing a magnetic sheet according to claim 1, wherein the nanocrystalline alloy ribbon is represented by a composition formula (Fe₁₋ₓAₓ)ₐSi_{b}B_{c}Cu_{d}Mₑ where A is at least one of Ni or Co, M is at least one selected from Nb, Mo, V, Zr, Hf, and W, and atomic percentages are 72.0≤a≤81.0, 9.0≤b≤18.0, 5.0≤c≤10.0, 0.02≤d≤1.5, 0.1≤e≤3.5, and 0≤x≤0.1.

11. The method for producing a magnetic sheet according to claim 1, wherein, when a bccFe crystallization starting temperature measured at a temperature increase rate 20 K/min of the amorphous alloy ribbon is defined as Tx1° C., the heater is heated to a heating temperature Ta of Tx1+80° C. or higher and Tx1+230° C. or lower.

12. The method for producing a magnetic sheet according to claim 1, wherein a pressure that presses the amorphous alloy ribbon against the heater is 0.03 MPa or greater.

13. The method for producing a magnetic sheet according to claim 1, wherein the nanocrystalline alloy ribbon has a saturation magnetic flux density Bs of 1.15 T or greater.

14. The method for producing a magnetic sheet according to claim 1, wherein a ratio (B80_{L}/B80_{W}) of a magnetic flux density B80_{L} when a magnetic field of 80 A/m is applied in a longitudinal direction of the magnetic sheet to a magnetic flux density B80_{W} when a magnetic field of 80 A/m is applied in a width direction orthogonal to the longitudinal direction is 0.60 to 1.40, and both the magnetic flux density B80_{L} and the magnetic flux density B80_{W} are 0.1 T or greater.
